(19) United States
(12) Patent Application Publication
(10) Pub. No.: US 2007/0044272 A1
(43) Pub. Date: Mar. 1, 2007

(54) Activation mechanism for a locking mechanism of a caster

(75) Inventor: Kenneth V. Misin, Sunnyvale, CA (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens Medical Solutions USA, Inc.

(21) Appl. No.: 11/217,909

(22) Filed: Aug. 31, 2005

(51) Int. Cl. B60B 33/00

(52) U.S. Cl. 16/35 R

(57) ABSTRACT

An activation mechanism for switching a locking mechanism of a caster between a plurality of locking modes is provided. The activation mechanism includes at least one actuation mechanism operatively connected to a connecting rod. The connecting rod is attached to a locking tab of the locking mechanism. The actuation mechanism includes a pair of vertically translatable pedal shafts, wherein the vertical displacement of the pedal shafts is transferred into lateral displacement of the connecting rod. The lateral displacement of the connecting rod actuates the locking tab so as to switch the locking mechanism between a plurality of locking modes.

### BACKGROUND

This invention relates to a caster having a locking mechanism. In particular, this invention relates to an activation mechanism for controlling the locking and unlocking of casters.

Casters are used on a variety of different portable structures. For example, diagnostic ultrasound systems typically include a box-shaped housing, or component cart for storing electrical components of the ultrasound system. The box-shaped housing generally has casters attached thereto so that the system can be easily transported to various locations. The ultrasound systems are used in rooms at the bedside of a patient, and the available area for maneuvering the ultrasound system within the room can be limited. As such, the ultrasound system may require controlled movement in order to position the component cart at a desired location.

The casters attached to a moveable structure generally have three distinct locking modes, including: (1) a brake or locked mode, (2) a direction lock mode, and (3) a swivel mode. These locking modes allow for the controlled movement of the structure in tight spaces. The casters are typically actuated by foot pedals located near the casters such that the user can adjust the locking mode while seated or standing upright.

When casters are attached to a component cart of a diagnostic ultrasound system, the foot pedals for the caster locking mechanism extend from a footrest disposed between the opposing casters at one end of the component cart. The foot pedals are centrally-located between the casters or adjacent to one of the casters. The user can only access the foot pedals easily from the front of the component cart. Additionally, the foot pedal typically pivots in a manner that requires a considerable amount of space adjacent to the component cart. A significantly-sized hole or notch is cut into the footrest to accommodate the pivoting movement of the pedal. The pivoting foot pedals are generally connected to the locking mechanism of the casters by way of a bar or cable linkage.

### BRIEF SUMMARY

The present embodiments provide an activation mechanism for switching the locking mode of a locking mechanism for a caster by transferring the vertical displacement of at least one pedal shaft into translational actuation of a locking tab on a caster.

In one aspect, an activation mechanism of a locking mechanism of a caster is provided. The activation mechanism includes at least one pedal shaft operatively connected to a locking tab of said locking mechanism, wherein vertical translation of said at least one pedal shaft causes lateral translation of said locking tab.

In another aspect, a method for actuating a locking tab of a locking mechanism of a caster is provided. The method includes actuating a first pedal shaft in a substantially vertical direction. The method further includes translating a connecting rod in a substantially lateral direction in response to the actuation of the first pedal shaft, wherein said connecting rod is operatively connected to the first pedal shaft. Finally, the method includes actuating the locking tab in response to lateral displacement of the connecting rod.

In yet another aspect, an activation mechanism for a locking mechanism of a caster is provided. The activation mechanism includes a first pedal shaft and a second pedal shaft operatively connected to a first rotatable gear, wherein the first pedal shaft and the second pedal shaft are vertically translatable. The activation mechanism further includes a third pedal shaft operatively connected to a second rotatable gear and a fourth pedal shaft operatively connected to a third rotatable gear, wherein the third and fourth pedal shafts are vertically translatable. The activation mechanism also includes a laterally translatable connecting rod operatively connected to the first, second, and third rotatable gears. Finally, the activation mechanism includes a clevis connector connecting the connecting rod to a locking tab of the locking mechanism. Vertical translation of one of the pedal shafts results in the lateral translation of the connecting rod and actuation of the locking tab, thereby switching the locking mechanism between at least two locking modes.

Advantages will become more apparent to those skilled in the art from the following description of embodiments which have been shown and described by way of illustration. As will be realized, the invention is capable of other and different embodiments, and its details are capable of modification in various respects. Accordingly, the drawings and description are to be regarded as illustrative in nature and not as restrictive.

### BRIEF DESCRIPTION OF THE DRAWINGS

The components and the figures are not necessarily to scale, emphasis instead being placed upon illustrating the principles of the invention. Moreover, in the figures, like reference numerals designate corresponding parts throughout the different views.

FIG. 1 is a perspective view of one embodiment of an activation mechanism for casters attached to a diagnostic ultrasound system component cart;

FIG. 2 is an exploded view of the activation mechanism of FIG. 1;

FIG. 3 is one embodiment of an actuation mechanism;

FIG. 4 is an alternative embodiment of an actuation mechanism;

FIG. 5 is a top view of the activation mechanism of FIG. 1; and

FIG. 6 is a front view of the activation mechanism of FIG. 1.

### DETAILED DESCRIPTION OF THE DRAWINGS AND THE PRESENTLY PREFERRED EMBODIMENTS

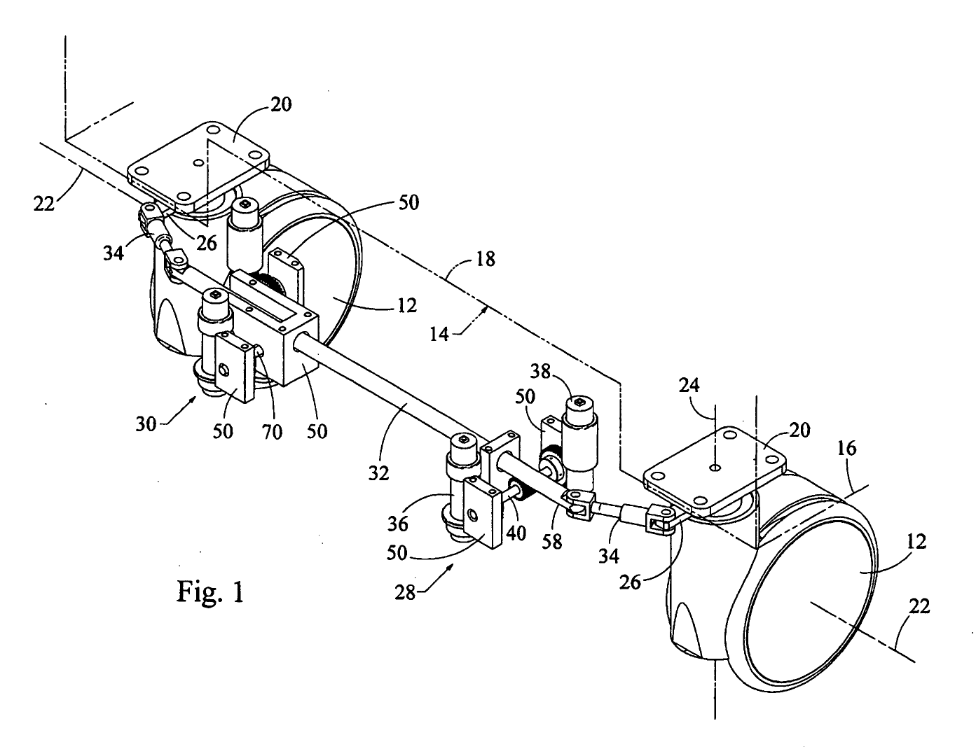

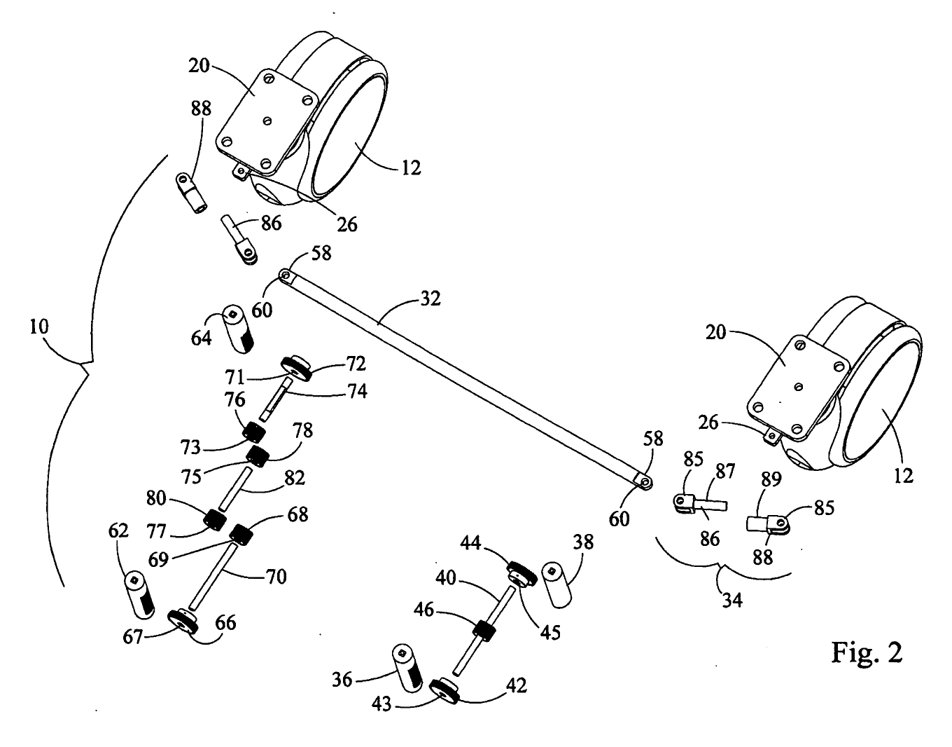

Referring to FIGS. 1-2, one embodiment of the components of an activation mechanism 10 for controlling the locking mode of at least one caster 12 is shown. The activation mechanism 10 extends between a pair of casters 12 disposed adjacent to opposing corners of a diagnostic ultrasound system component cart 14 (shown in dashed lines). While the exemplary embodiment of the activation mechanism 10 for actuating the locking mechanism of a caster 12 attached to a component cart 14 for a diagnostic ultrasound system, the activation mechanism 10 can be used to actuate the locking mechanism of a caster 12 attached to any portable structure. The activation mechanism 10 can be used to control any number of casters 12 attached to a component cart 12. The casters 12 allow the component cart 14 to be moved between desired locations.

In one embodiment, the activation mechanism 10 is disposed adjacent to a side edge 16 of a component cart 14 such that the activation mechanism 10 connects a caster 12 located adjacent the front of the component cart 14 and a caster 12 located at the rear of the component cart 14 adjacent the same side edge 16 of the component cart 14. In another embodiment, as illustrated in FIG. 1, the activation mechanism 10 is disposed adjacent to an end edge 18 of the component cart 14, thereby connecting the casters 12 located at the front end adjacent to the front edge 18 of the component cart 14 or connecting the casters 12 located at the rear end adjacent to the rear edge 18 of the component cart 14. In yet another embodiment, the activation mechanism 10 extends between a plurality of casters 12 diagonally or not linearly aligned.

Each caster 12 is operatively attached to the component cart 14 by way of a plate 20. The casters 12 rotate about a generally horizontal axis 22 to provide rolling movement for the component cart 14. The casters 12 also swivel about a generally vertical axis 24 so as to allow the component cart 14 to be turned when moved. The caster 12 includes a locking tab 26 that is actuatable between a first, second, and third position so as to provide the caster 12 with three distinct locking modes. In the first locking mode, the caster 12 is prevented from both rotating about the horizontal axis 22 and swiveling about the vertical axis 24. In the second locking mode, the caster 12 is prevented from swiveling about the vertical axis 24, thereby allowing the caster to translate along the ground in a linear direction. In the third locking mode, the caster 12 is free to both rotate about horizontal axis 22 and swivel about the vertical axis 24. Different or fewer locking modes may be provided.

The activation mechanism 10 controls the locking mode of at least one caster 12, as shown in FIGS. 1-2. The activation mechanism 10 includes at least a first actuation mechanism 28 or a second actuation mechanism 30, a connecting rod 32, and a pair of clevis connectors 34 operatively connected to each end of the connecting rod 32. The first and second actuation mechanisms 28, 30 are user-controlled such that actuation of either the first actuation mechanism 28 or the second actuation mechanism 30 causes the locking tab 26 on the caster 12 to be moved, thereby changing the locking mode of the casters 12 operatively connected to the activation mechanism 10.

One embodiment of an actuation mechanism, the first actuation mechanism 28, is shown in FIGS. 1-3. The first actuation mechanism 28 includes a first pedal shaft 36, a second pedal shaft 38, a first rod 40, a first transfer gear 42, a second transfer gear 44, and a third transfer gear 46. The first pedal shaft 36 is a cylindrically-shaped, elongated member having a first rack gear 48 located on the outer, circumferential surface of the first pedal shaft 36. The first pedal shaft 36 can be of any shape or size sufficient to withstand the movements and stresses associated with actuating the first pedal shaft 36 as well as having a length sufficient to provide the first actuating mechanism 28 with a desired range of motion of the first pedal shaft 36. The first rack gear 48 includes a plurality of grooves formed in the outer, circumferential surface of the first pedal shaft 36 in a circumferentially-oriented manner. The grooves of the first rack gear 48 on the first pedal shaft 36 are in meshing engagement with the teeth of the first transfer gear 42, thereby forming a rack-and-pinion gear between the first pedal shaft 36 and the first transfer gear 42. The first pedal shaft 36 is secured in a vertically-oriented manner to a footrest (not shown) which is attached to the component cart 14. The first pedal shaft 36 is secured to the footrest such that the first pedal shaft 36 is translatable in a vertical, reciprocating manner. The number of grooves forming the first rack gear 48 provides an upper and lower limit to the reciprocating range of motion for the first pedal shaft 36. The first pedal shaft 36 can be operatively connected to the first rod 40 by any manner sufficient to convert linear displacement of the first pedal shaft 36 into rotational movement of the first rod 40.

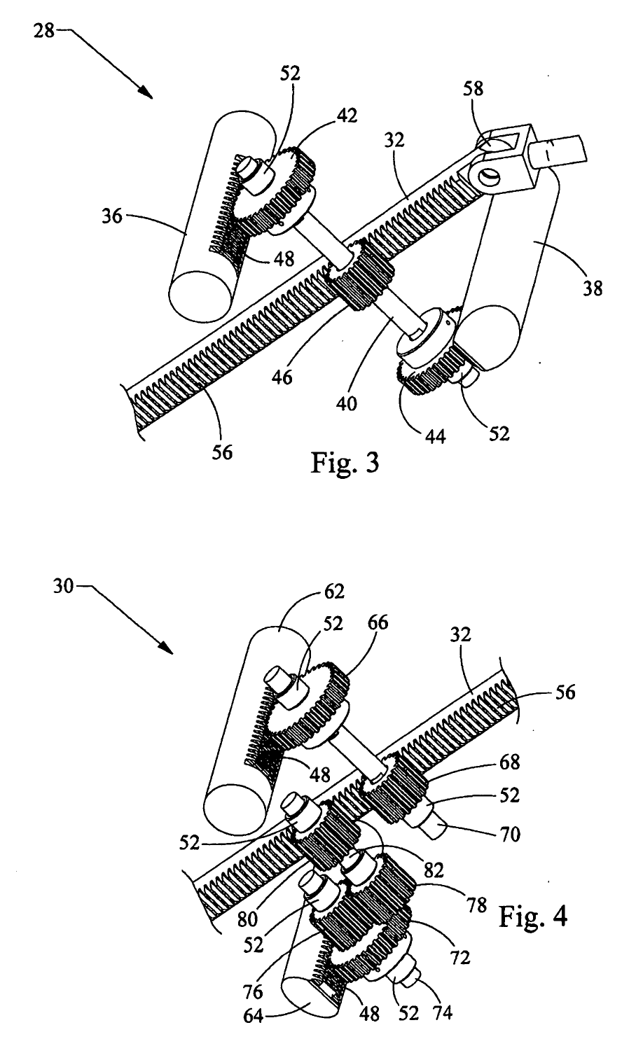

The first transfer gear 42 is operatively connected to the first rod 40, as illustrated in FIGS. 2-3. The first transfer gear 42 is a pinion gear having a substantially cylindrical shape, wherein gear teeth are outwardly-directed from the circumferential surface of the first transfer gear 42. A first aperture 43 is formed through the longitudinal axis of the first transfer gear 42, and the first aperture 43 receives the first rod 40. The first transfer gear 42 is secured to the first rod 40 such that the rotational movement of the first transfer gear 42 is transmitted to the first rod 40, thereby causing the first rod 40 to rotate in a like manner. The first rod 40 is operatively connected to the component cart 14 by way of a securing member 50 located at the opposing distal ends of the first rod 40, wherein a bearing 52 is disposed between each distal end of the first rod 40 and the corresponding securing member 50, as illustrated in FIGS. 1 and 3, so as to allow the first rod 40 to rotate about its longitudinal.

The first pedal shaft 36 is operatively connected to the second pedal shaft 38 by way of the first rod 40, as shown in FIGS. 1-3. The second pedal shaft 38 is a cylindrically-shaped, elongated member having a first rack gear 48, as shown in FIG. 6, located on the outer, circumferential surface of the second pedal shaft 38. The second pedal shaft 38 can be of any shape or size sufficient to withstand the movements and stresses associated with actuating the second pedal shaft 38 as well as having a length sufficient to provide the first actuating mechanism 28 with a desired range of motion of the second pedal shaft 38. The first rack gear 48 includes a plurality of grooves formed in the outer, circumferential surface of the second pedal shaft 38 in a circumferentially-oriented manner. The grooves of the first rack gear 48 on the second pedal shaft 38 are in meshing engagement with the teeth of the second transfer gear 44, as illustrated in FIGS. 2-3, thereby forming a rack-and-pinion gear between the second pedal shaft 38 and the second transfer gear 44. The second pedal shaft 38 is secured in a vertically-oriented manner to the footrest (not shown) which is connected to the component cart 14. The second pedal shaft 38 is secured to the footrest such that the second pedal shaft 38 is translatable in a vertical, reciprocating manner. The number of grooves forming the first rack gear 48 provides an upper and lower limit to the reciprocating range of motion for the second pedal shaft 38. The second pedal shaft 38 can be operatively connected to the first rod 40 by any manner sufficient to convert linear movement of the second pedal shaft 38 into rotational movement of the first rod 40.

The second transfer gear 44 is operatively connected to the first rod 40, as illustrated in FIGS. 2-3. The second transfer gear 44 is a pinion gear having a substantially cylindrical shape, wherein gear teeth are outwardly-directed from the circumferential surface of the second transfer gear 44. A second aperture 45 is formed through the longitudinal axis of the second transfer gear 44, and the second aperture 45 receives the first rod 40. The second transfer gear 44 is secured to the first rod 40 such that the rotational movement of the second transfer gear 44 is transmitted to the first rod 40, thereby causing the first rod 40 to rotate in a like manner. The first and second transfer gears 42, 44 are integrally connected to the first rod 40, but the first transfer gear 42, the second transfer gear 44, or both the first and second transfer gears 42, 44 can be produced with the first rod 40 as a single part. In one embodiment, the first and second transfer gears 42, 44 are equivalent gears such that they both have the same gear characteristics including, but not limited to, material, size, and number of gear teeth. In an alternative embodiment, the characteristics of the first transfer gear 42 are different than the characteristics of the second transfer gear 44.

A third transfer gear 46, as shown in FIGS. 1-3, is secured to the first rod 40. The third transfer gear 46 is a pinion gear having a substantially cylindrical shape, wherein the gear teeth are outwardly-directed from the circumferential surface of the third transfer gear 46. The third transfer gear 46 is integrally connected to the first rod 40, but the third transfer gear 46 and the first rod 40 can be formed as a single part. The third transfer gear 46 transmits the rotational movement of the first rod 40 to the connecting rod 32 by way of meshing engagement between the third transfer gear 46 with the second rack gear 56 located on the connecting rod 32. The third transfer gear 46 forms a rack-and-pinion gear with the second rack gear 56, but any other type of transfer mechanism can be used to transfer the vertical translational movement of the first and second pedal shafts 36, 38 into lateral translational movement of the connecting rod 32.

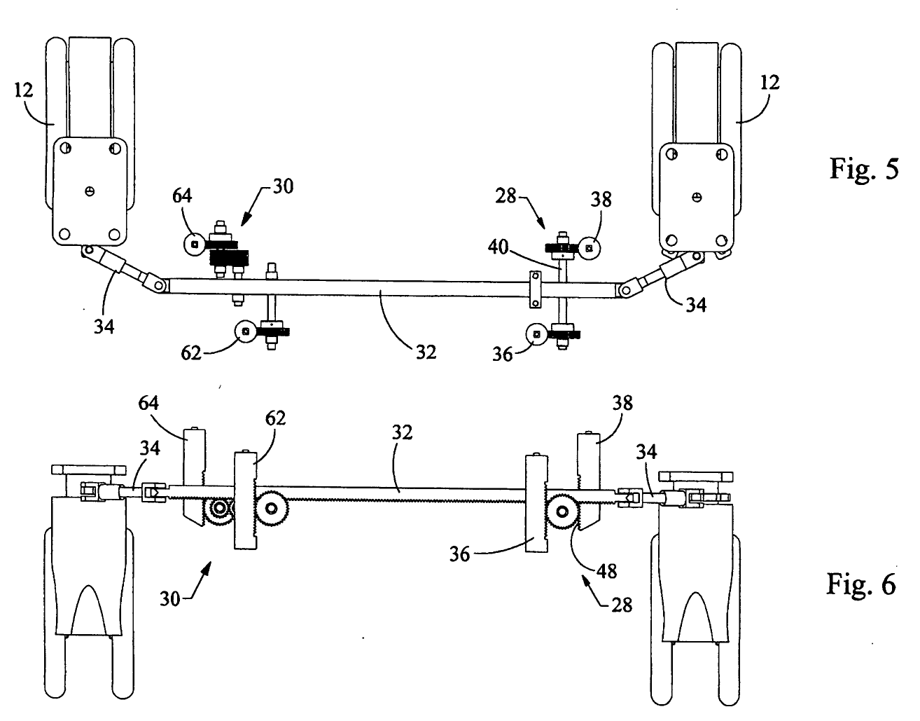

In operation, the first and second pedal shafts 36, 38 of the first actuation mechanism 28 are translatable in the vertical direction in an opposing reciprocal manner. As the first pedal shaft 36 is depressed by the user relative to the footrest (not shown), thereby causing the first pedal shaft 36 to translate in a downward direction, the translating movement of the first pedal shaft 36 causes the first, second, and third transfer gears 42, 44, 46 to rotate in a corresponding angular direction. The first and second pedal shafts 36, 38 are disposed adjacent to opposing lateral sides of the first rod 40, as shown in FIGS. 5-6, such that rotation of the first transfer gear 42 resulting from the downward movement of the first pedal shaft 36 is transmitted to the second transfer gear 44 by way of the first rod 40 so as to cause the second transfer gear 44 to rotate in the same angular direction as the first transfer gear 42. As a result, the second pedal shaft 38 translates in an upward, vertical direction.

In a similar manner, as the second pedal shaft 38 is depressed by the user relative to the footrest (not shown), thereby causing the second pedal shaft 38 to translate in a downward direction, the first, second, and third transfer gears 42, 44, 46 rotate in the same relative angular direction resulting in the first pedal shaft 36 translating upwardly. The angular rotational direction of the first, second, and third transfer gears 42, 44, 46 resulting from the depression of the first pedal shaft 36 is opposite the angular rotational direction of the first, second, and third transfer gears 42, 44, 46 resulting from the depression of the second pedal shaft 38. Rotation of the first rod 40 resulting from the vertical displacement of the first and second pedal shafts 36, 38 also cause the third transfer gear 46 to rotate, thereby causing the connecting rod 32 to translate in a substantially horizontal manner as a result of the meshing engagement between the third transfer gear 46 and the second rack gear 56 disposed on the connecting rod 32.

The first rod 40 is secured to the component cart 14 by way of the securing members 50 such that translation of the first rod 40 is constrained. As the first rod 40 and third transfer gear 46 rotates in response to the depression of the first or second pedal shafts 36, 38, the connecting rod 32 is forced to translate in a lateral, substantially horizontal manner due to the meshing engagement between the third transfer gear 46 and the second rack gear 56 on the connecting rod 32.

In one embodiment, the gearing ratios of the first transfer gear 42 and the second transfer gear 44 are equal such that the vertical displacement of the first pedal shaft 36 is equal to the vertical displacement of the second pedal shaft 38, but in opposite directions. In an alternative embodiment, the gearing ratio of the first transfer gear 42 is different than that of the second transfer gear 44 such that the vertical displacement of the first pedal shaft 36 is greater than the vertical displacement of the second pedal shaft 38 when either the first or second pedal shaft 36, 38 is depressed. In a further alternative embodiment, the gearing ratios of the first transfer gear 42 is different than that of the second transfer gear 44 such that the vertical displacement of the second pedal shaft 38 is greater than the vertical displacement of the first pedal shaft 36 when either the first or second pedal shaft 36, 38 is depressed.

The first pedal shaft 36 and the second pedal shaft 38 of the first actuation mechanism 28 are offset with respect to each other relative to the longitudinal direction of the first rod 40, as illustrated in FIG. 5-6. The first and second pedal shafts 36, 38 are disposed on opposing sides of the first rod 40 such that the vertical displacement of either shaft does not interfere with the ability of the user to actuate the other shaft. For example, when a user depresses the second pedal shaft 38, the first pedal shaft 36 is raised. Because the first pedal shaft 36 is offset relative to the second pedal shaft 38, the raised first pedal shaft 36 should not contact the user's foot. This allows the user to continue depressing the second pedal shaft 38 without interference from the first pedal shaft 36. In a similar manner, when a user depresses the first pedal shaft 36, the second pedal shaft 38 is raised but does not interfere with the user's ability to continue depressing the first pedal shaft 36.

The first and second pedal shafts 36, 38 are translatable between a first operative position, a second operative position, and a third operative position. Each operative position of the first and second pedal shafts 36, 38 corresponds to one of the three locking modes of the locking mechanism for the casters 12.

An alternative embodiment of an actuation mechanism, the second actuating mechanism 30, is shown in FIGS. 1-2 and 4. The second actuating mechanism 30 includes a third pedal shaft 62, a fourth pedal shaft 64, a fourth transfer gear 66, a fifth transfer gear 68, a second rod 70, a sixth transfer gear 72, a third rod 74, a seventh transfer gear 76, a first idler gear 78, a second idler gear 80, and a fourth rod 82.

The third pedal shaft 62 is a cylindrically-shaped, elongated member having a first rack gear 48 located on the outer, circumferential surface of the third pedal shaft 62, as shown in FIGS. 1-2 and 4. The third pedal shaft 62 can be of any shape or size sufficient to withstand the movements and stresses associated with actuating the third pedal shaft 62 as well as having a length sufficient to provide the second actuating mechanism 30 with a desired range of motion of the third pedal shaft 62. The first rack gear 48 includes a plurality of grooves formed in the outer, circumferential surface of the third pedal shaft 62 in a circumferentially-oriented manner. The grooves of the first rack gear 48 on the third pedal shaft 62 are in meshing engagement with the teeth of the fourth transfer gear 66, thereby forming a rack-and-pinion gear between the third pedal shaft 62 and the fourth transfer gear 66. The third pedal shaft 62 is secured in a vertically-oriented manner to the footrest (not shown) which is connected to the component cart 14. The third pedal shaft 62 is secured to the footrest such that the third pedal shaft 62 is translatable in a vertical, reciprocating manner. The number of grooves forming the first rack gear 48 provides an upper and lower limit to the reciprocating range of motion for the third pedal shaft 62. The third pedal shaft 62 can be operatively connected to the second rod 70 in any manner sufficient to convert linear displacement of the third pedal shaft 62 into rotational movement of the second rod 70.

A fourth transfer gear 66 and a fifth transfer gear 68 are secured to the second rod 70, as shown in FIG. 4. The fourth and fifth transfer gears 66, 68 are pinion gears, each having a substantially cylindrical shape, wherein gear teeth are outwardly-directed from the circumferential surface of each of the fourth and fifth transfer gears 66, 68. The fourth transfer gear 66 has a third aperture 67 formed therethrough, and the fifth transfer gear 68 has a fourth aperture 69 formed therethrough. The third and fourth apertures 67, 69 are shaped to receive the second rod 70, as shown in FIG. 2. The fourth and fifth transfer gears 66, 68 are integrally connected to the second rod 70, but the fourth transfer gear 66, the fifth transfer gear 68, or both the fourth and fifth transfer gears 66, 68 can be produced with the second rod 70 as a single part.

The fifth transfer gear 68 transmits the rotational movement of the second rod 70 to the connecting rod 32 by way of meshing engagement between the fifth transfer gear 68 and the second rack gear 56 located on the connecting rod 32. The fifth transfer gear 68 forms a rack-and-pinion gear with the second rack gear 56 on the connecting rod 32, but any of the type of transfer mechanism can be used to transfer the vertical displacement of the third pedal shaft 62 into lateral translational movement of the connecting rod 32. The second rod 70 is operatively connected to the component cart 14 by way of a securing member 50 located at the opposing distal ends of the second rod 70, wherein a bearing 52 is disposed between each distal end of the second rod 70 and a corresponding securing member 50, as illustrated in FIGS. 1 and 4, so as to allow the second rod 70 to rotate about the longitudinal axis of the second rod 70.

The third pedal shaft 62 of the second actuation mechanism 30 is operatively connected to the fourth pedal shaft 64 by way of the connecting rod 32, as shown in FIG. 4. The fourth pedal shaft 64 is a cylindrically-shaped, elongated member having a first rack gear 48 located on the outer, circumferential surface of the fourth pedal shaft 64. The fourth pedal shaft 64 can be of any shape or size sufficient to withstand the movements and stresses associated with actuating the fourth pedal shaft 64 as well as having a length sufficient to provide the second actuating mechanism 30 with a desired range of motion of the fourth pedal shaft 64. The first rack gear 48 includes a plurality of grooves formed in the outer, circumferential surface of the fourth pedal shaft 64 in a circumferentially-oriented manner. The grooves of the first rack gear 48 on the fourth pedal shaft 64 are in meshing engagement with the teeth of the sixth transfer gear 72, thereby forming a rack-and-pinion gear between the fourth pedal shaft 64 and the sixth transfer gear 72. The fourth pedal shaft 64 is secured in a vertically-oriented manner to a footrest (not shown) which is connected to the component cart 14. The fourth pedal shaft 64 is secured to the footrest such that the fourth pedal shaft 64 translates in a vertical, reciprocating manner. The number of grooves forming the first rack gear 48 on the fourth pedal shaft 64 provides an upper and lower limit to the reciprocating range of motion for the fourth pedal shaft 64. The fourth pedal shaft 64 can be operatively connected to the third rod 74 by any manner sufficient to convert linear movement of the fourth pedal shaft 64 into rotational movement of the third rod 74.

The sixth transfer gear 72 and a seventh transfer gear 76 are secured to the third rod 74, as shown in FIGS. 2 and 4. The sixth and seventh transfer gears 72, 76 are pinion gears, each having a substantially cylindrical shape, wherein gear teeth are outwardly-directed from the circumferential surface of each of the sixth and seventh transfer gears 72, 76. The sixth transfer gear 72 has a fifth aperture 71 formed therethrough, and the seventh transfer gear 76 has a sixth aperture 73 formed therethrough, as shown in FIG. 2. The fifth and sixth apertures 71, 73 are shaped to receive the third rod 74. The sixth and seventh transfer gears 72, 76 are integrally connected to the third rod 74, but the sixth transfer gear 72, the seventh transfer gear 76, or both the sixth and seventh transfer gears 72, 76 can be produced with the third rod 74 as a single part. The seventh transfer gear 76 is meshingly engaged with the first idler gear 78, thereby transmitting the rotational movement of the third rod 74 to the first idler gear 78. The third rod 74 is operatively connected to the component cart 14 by way of a securing member 50 located at both opposing distal ends of the third rod 74, wherein a bearing 52 is disposed about the circumference at each distal end of the third rod 74. When assembled, the bearings 52 are located between the outer surface of each distal end of the third rod 74 and within an aperture in the corresponding securing member 50, as illustrated in FIGS. 1 and 4, so as to allow the third rod 74 to rotate about its longitudinal axis.

The sixth transfer gear 72 and seventh transfer gear 76 are operatively connected to the third rod 74, as illustrated in FIGS. 2 and 4, such that rotation of the sixth transfer gear 72, resulting from the vertical displacement of the fourth pedal shaft 64, causes the sixth and seventh transfer gears 72, 76 to rotate in the same direction. The seventh transfer gear 76 is meshingly engaged with the first idler gear 78 such that the rotational output of the seventh transfer gear 76 is transmitted to the first idler gear 78.

The first idler gear 78 and a second idler gear 80 are operatively connected to the fourth rod 82, as illustrated in FIG. 4. The first and second idler gears 78, 80 are pinion gears having gear teeth outwardly-directed from the circumferential surface of each gear. The first idler gear 78 includes a seventh aperture 75 formed therethrough, and the second idler gear 80 includes an eighth aperture 77 formed therethrough, as illustrated in FIG. 2. The second idler gear 80 is meshingly engaged with the second rack gear 56 on the connecting rod 32. The seventh and eighth apertures 75, 77 are shaped to receive the fourth rod 82. In one embodiment, the first and second idler gears 78, 80 are integrally attached to the fourth rod 82. In an alternative embodiment, the first idler gear 78, the second idler gear 80, or both the first and second idler gears 78, 80 can be produced with the fourth rod 82 as a single part. The second idler gear 80 transmits the rotational movement of the fourth rod 82 to the connecting rod 32 by way of meshing engagement between the second idler gear 80 and the second rack gear 56 located on the connecting rod 32. The second idler gear 80 forms a rack-and-pinion gear with the second rack gear 56 on the connecting rod 32, but any of the type of transfer mechanism can be used to transfer the vertical displacement of the fourth pedal shaft 64 into lateral translational movement of the connecting rod 32. The fourth rod 82 includes a pair of bearings 52 attached thereto, as illustrated in FIGS. 1 and 4. One bearing 52 is disposed about the circumference of the fourth rod 82 at the distal end of the fourth rod 82 adjacent to the second idler gear 80, and the other bearing 52 is disposed about the circumference of the fourth rod 82 and between the first and second idler gears 78, 80. When assembled, the bearings 52 on the fourth rod 82 are located between the outer surface of the fourth rod 82 and a within an aperture in the corresponding securing member 50 so as to allow the fourth rod 82 to rotate about its longitudinal axis.

In operation, the third and fourth pedal shafts 62, 64 of the second actuation mechanism 30 are translatable in the vertical direction in an opposing reciprocal manner. As the third pedal shaft 62 is depressed by the user relative to the footrest (not shown), thereby causing the third pedal shaft 62 to translate in a downward direction, the translating movement of the third pedal shaft 62 causes the fourth and fifth transfer gears 66, 68 to rotate. Because the second rod 70 is constrained from any translational movement, the rotation of the fifth transfer gear 68 that is in meshing engagement with the second rack gear 56 on the connecting rod 32 causes the connecting rod 32 to translate in a lateral, substantially horizontal manner. Because the fourth rod 82 is secured to the component cart 14, the fourth rod 82 has no translational movement such that lateral displacement of the connecting rod 32 causes the fourth rod 82 to rotate by way of the meshing engagement between the second rack gear 56 on the connecting rod 32 and the second idler gear 80. Rotation of the second idler gear 80 causes the fourth rod 82 to rotate, thereby resulting in rotation of the first idler gear 78 in the same rotational direction as the second idler gear 80. The angular rotation of the first idler gear 78 is transmitted to the third rod 74 by way of meshing engagement between the first idler gear 78 and the seventh transfer gear 76. As the seventh transfer gear 76 rotates, the sixth transfer gear 72 that is integrally attached to the third rod 74 rotates in the same direction as the seventh transfer gear 76. Rotational movement of the sixth transfer gear 72 is transmitted to the fourth pedal shaft 64 by way of the meshing engagement between the sixth transfer gear 72 and the first rack gear 48 on the fourth pedal shaft 64, wherein the fourth pedal shaft 64 translates in an upward direction, the direction opposite the movement of the third pedal shaft 62. In a similar manner, the depression of the fourth pedal shaft 64 causes the vertically-upward translation of the third pedal shaft 62 by causing each of the gears and rods of the second actuation mechanism 30 to rotate in a direction opposite the rotational direction of the same gears and rods as when the third pedal shaft 62 is depressed by the user.

In one embodiment, as shown in FIGS. 5-6, the first and third pedal shafts 36, 62 are offset inwardly and forwardly with respect to the casters 12 relative to the second and fourth pedal shafts 38, 64. In this orientation of the activation mechanism 10, when the user depresses the first pedal shaft 36, the third pedal shaft 62 is similarly depressed relative to the footrest (not shown) as the second and fourth pedal shafts 38, 64 are raised. Because the second and fourth pedal shafts 38, 64 are disposed outwardly from the first and third pedal shafts 36, 62, the gearing structure of the first actuation mechanism 28 cannot be mirrored so as to cause the third and fourth pedal shafts 62, 64 to translate in a manner similar to the corresponding pedal shaft in the first actuation mechanism 28. Hence, the first and second idler gears 78, 80 are incorporated so that the fourth pedal shaft 64 translates in the same vertical direction as the second pedal shaft 38 and in the opposite vertical direction as the third pedal shaft 62. The third and fourth pedal shafts 62, 64 are oriented such that the first rack gear 48 of each pedal shaft is directed in the same lateral direction, and the first and second idler gears 78, 80 act to cause the sixth transfer gear 72 to rotate in a rotational direction opposite the direction of rotation of the fourth transfer gear 66. As a result, the downward translation of the third pedal shaft 62 causes the upward translation of the fourth pedal shaft 64, and the downward translation of the fourth pedal shaft 64 causes the upward translation of the third pedal shaft 62. In an alternative embodiment, the first and third pedal shafts 36, 62 are disposed outwardly and forwardly with respect to the casters 12 relative to the second and fourth pedal shafts 38, 64.

The second, third, and fourth rods 70, 74, 82 of the second actuation mechanism 30 are aligned in a substantially parallel manner, as illustrated in FIGS. 4-6. The first rack gear 48 of both the third and fourth pedal shafts 62, 64 are directed in the same direction. The third and fourth pedal shafts 62, 64 are aligned in an offset manner relative to the direction transverse to the connecting rod 32. The third and fourth pedal shafts 62, 64 are offset such that the vertical displacement of either shaft does not interfere with the ability of the user to actuate the other shaft. For example, when a user depresses the third pedal shaft 62, the fourth pedal shaft 64 is raised. Because the third pedal shaft 62 is offset relative to the fourth pedal shaft 64, the raised fourth pedal shaft 64 should not contact the user's foot. This allows the user to continue depressing the third pedal shaft 62 without interference from the fourth pedal shaft 64. In a similar manner, when a user depresses the fourth pedal shaft 64, the third pedal shaft 62 is raised but does not interfere with the user's ability to continue depressing the fourth pedal shaft 64.

The third and fourth pedal shafts 62, 64 are translatable between a first operative position, a second operative position, and a third operative position. Each operative position of the third and fourth pedal shafts 62, 64 corresponds to one of the three locking modes of the locking mechanism for the casters 12.

The first and second actuating mechanisms 28, 30 are operatively connected to the connecting rod 32, as illustrated in FIGS. 1-6. The connecting rod 32 is an elongated, cylindrically or other shaped member extending in a lateral manner and is operatively connected to at least one caster 12. The connecting rod 32 includes a second rack gear 56 formed on the outer surface thereof. The second rack gear 56 receives the third transfer gear 46 of the first actuating mechanism 28 as well as the fifth transfer gear 68 and the second idler gear 80 of the second actuating mechanism 30 in meshing engagement. Because the translational movement of the rods of both the first and second actuation mechanisms 28, 30 are constrained, vertical displacement of the first or second pedal shafts 36, 38 of the first actuation mechanism 28 or vertical displacement of the third or fourth pedal shafts 62, 64 of the second actuation mechanism 30 results in the lateral translation of the connecting rod 32 as well as the vertical actuation of each of the other pedal shafts in an upward or downward manner.

The connecting rod 32 has a generally tubular shape and is oriented in a substantially horizontal manner, wherein each of the opposing distal ends of the connecting rod 32 has a flattened section 58, as illustrated in FIGS. 2-3. Each flattened section 58 of the connecting rod 32 includes an aperture 60 formed therethrough. A clevis connector 34 operatively connects each opposing flattened section 58 of the connecting rod 32 with the corresponding locking tab 26 on a caster 12.

The clevis connector 34 includes a male portion 86 and a female portion 88, as shown in FIG. 2. The male portion 86 of the clevis connector 34 includes a first u-shaped portion 85 in which the legs of the first u-shaped portion 85 are disposed adjacent to the opposing surfaces of the flattened section 58 of the connecting rod 32. A pin (not shown) is disposed through an aperture in each leg of the u-shaped portion 85 as well as the aperture 60 in the flattened section 58 of the connecting rod 32 in order to connect the clevis connector 34 to the connecting rod 32. An extending rod 87 extends from the first u-shaped portion 85 of the clevis connector 34. The female portion 88 includes a receiving member 89, wherein the receiving member 89 has an aperture formed therein for receiving the extending rod 87 of the male portion 86. The aperture of the receiving member 89 has substantially the same cross-sectional area as the extending rod 87 such that the male and female portions 86, 88 are easily connected. A u-shaped portion 85 extends from the receiving member 89 of the female portion 88. The legs of the second u-shaped portion 89 are disposed adjacent to the opposing surfaces of the locking tab 26 of the corresponding caster 12, and a pin (not shown) is disposed through an aperture formed through both legs of the u-shaped portion 89 as well as an aperture in the locking tab 26, thereby operatively connecting the activation mechanism 10 to at least one caster 12.

Activation of either the first or second actuation mechanism 28, 30 as a result of depressing one of the first, second, third, or fourth pedal shafts 36, 38, 62, 64 results in the lateral translation of the connecting rod 32, whereby the locking tab 26 translates so as to switch the locking tab 26 between a first, second, or third locking positions corresponding to the first, second and third locking modes, respectively. In one embodiment, the locking tab 26 produces an auditory noise to indicate when the locking tab 26 is located in one of the three locking mode positions such that the user can cease the depression of a pedal shaft.

In one embodiment, the activation mechanism 10 includes a first actuation mechanism 28 and a second actuation mechanism 30 operatively connected to one, two or more casters 12 so as to control the locking mode of the casters 12. In an alternative embodiment, the activation mechanism 10 includes one of either a single one or a pair of first actuation mechanisms 28 or second actuation mechanisms 30 operatively connected to the casters 12 so as to control the locking mechanism of the casters 12. In a further alternative embodiment, the activation mechanism 10 includes one of either a first actuation mechanism 28 or a second actuation mechanism 30 operatively connected to a single caster 12 so as to control the locking mechanism of the caster 12. The activation mechanism 10 attached to a component cart 14 can be controlled by either a single actuation mechanism 28, 30, multiple actuation mechanisms 28, 30 of the same embodiment, or multiple actuation mechanisms 28, 30 having different embodiments. The number of casters 12 controlled by the activation mechanism 10 can also vary depending upon the design of the component cart 14 to which the casters 12 are attached.

The first, second, third, and fourth pedal shafts 36, 38, 62, 64 translate in a reciprocating vertical manner so as to control the locking mechanism of at least one caster 12 to which the pedal shafts are operatively connected. When compared to a pivoting pedal used to actuate the locking mechanism, the vertical movement of the pedal shafts 36, 38, 62, 64 may require less space to switch the locking mode of the locking mechanism of each caster. The vertical displacement of pedal shafts 36, 38, 62, 64 that are operatively connected to the locking mechanism of the casters 12 may require less space, thus providing a more efficient use of the space for a component cart 14.

While preferred embodiments of the invention have been described, it should be understood that the invention is not so limited and modifications may be made without departing from the invention. The scope of the invention is defined by the appended claims, and all devices that come within the meaning of the claims, either literally or by equivalence, are intended to be embraced therein.

1. An activation mechanism of a locking mechanism of a caster comprising:
at least one pedal shaft operatively connected to a locking tab of said locking mechanism, wherein vertical translation of said at least one pedal shaft causes lateral translation of said locking tab.

2. The activation mechanism of claim 1, wherein said at least one pedal shaft is translatable in a reciprocating manner.

3. The activation mechanism of claim 1 further including a connecting rod operatively connected to said at least one pedal shaft and said locking tab.

4. The activation mechanism of claim 3, wherein a first distal end of a clevis connector is attached to a distal end of said connecting rod, and a second distal end of said clevis connector is attached to said locking tab.

5. The activation mechanism of claim 1, wherein said at least one pedal shaft includes a first pedal shaft and a second pedal shaft.

6. The activation mechanism of claim 5, wherein said first pedal shaft and said second pedal shaft translate in an opposing reciprocal manner.

7. The activation mechanism of claim 5, wherein said first pedal shaft and said second pedal shaft have a first rack gear formed thereon.

8. The activation mechanism of claim 7, wherein said connecting rod has a second rack gear formed thereon.

9. The activation mechanism of claim 8, wherein said first rack gear of said first pedal shaft is meshingly engaged with a first transfer gear that is integrally attached to a rotatable first rod, and a second transfer gear being meshingly engaged with said second rack gear formed on said connecting rod is integrally attached to said first rod.

10. The activation mechanism of claim 9, wherein translational displacement of said first pedal shaft is transferred to rotational movement of said first rod by way of said first transfer gear in meshing engagement with said first rack gear of said first pedal shaft, and rotational movement of said first rod is transferred to lateral translation of said connecting rod by way of said second transfer gear in meshing engagement with said second rack gear of said connecting rod.

11. The activation mechanism of claim 9, wherein a third transfer gear is integrally attached to said first rod, and said third transfer gear is in meshing engagement with said first rack gear of said second transfer pedal.

12. The activation mechanism of claim 9, wherein translational displacement of said first pedal shaft is transferred to rotational movement of said first rod, and rotational movement of said first rod is transferred to translational displacement of said second pedal.

13. The activation mechanism of claim 7, wherein translational displacement of said first pedal shaft results in vertical displacement of said second pedal shaft in an opposing direction relative to the direction of translational displacement of said first pedal shaft.

14. The activation mechanism of claim 9, wherein said first pedal shaft is offset relative to said second pedal shaft with respect to a longitudinal axis of said first rod.

15. The activation mechanism of claim 8, wherein said first rack gear of said second pedal shaft is meshingly engaged with a third transfer gear that is integrally connected to a second shaft having a fourth transfer gear integrally attached thereto, and said fourth transfer gear is operatively connected to said connecting rod.

16. The activation mechanism of claim 15, wherein said fourth transfer gear is meshingly engaged with a first idler gear that is integrally attached to a third rod, and a second idler gear that is meshingly engaged with said second rack gear of said connecting rod is integrally attached to said third rod.

17. The activation mechanism of claim 1, wherein said caster is attached to a component cart for a diagnostic ultrasound system.

18. A method for actuating a locking tab of a locking mechanism for a caster, said method comprising:
actuating a first pedal shaft in a substantially vertical direction;
translating a connecting rod in a substantially lateral direction in response to actuation of said first pedal shaft, wherein said connecting rod is operatively connected to said first pedal shaft;
actuating said locking tab in response to lateral displacement of said connecting rod.

19. The method of claim 18, wherein translation of said connecting rod actuates said locking tab between a first locking position, a second locking position, and a third locking position.

20. The method of claim 18, wherein actuation of said first pedal shaft results in a second pedal shaft being actuated in a direction opposite that of said first pedal shaft.

21. An activation mechanism of a locking mechanism for a caster, said activation mechanism comprising:
a first pedal shaft and a second pedal shaft operatively connected to a first rotatable gear, wherein said first pedal shaft and said second pedal shaft are vertically translatable;
a third pedal shaft operatively connected to a second rotatable gear, wherein said third pedal shaft is vertically translatable;
a fourth pedal shaft operatively connected to a third rotatable gear, wherein said fourth pedal shaft is vertically translatable;
a laterally translatable connecting rod operatively connected to said first rotatable gear, said second rotatable gear, and said third rotatable gear; and a clevis connector connecting said connecting rod to a locking tab of said locking mechanism, wherein vertical translation of one of said first pedal shaft, said second pedal shaft, said third pedal shaft, or said fourth pedal shaft results in the lateral translation of said connecting rod and actuation of said locking tab, thereby switching said locking mechanism between at least two locking modes.
